(19) United States
(12) Patent Application Publication
(10) Pub. No.: US 2010/0007202 A1
(43) Pub. Date: Jan. 14, 2010

(54) Combined Service Brake and Spring Brake Cylinder Comprising a Connection Coupling for a Pressure Medium

(75) Inventors: Franck HEMERY, Honfleur (FR); Alain FANTAZI, Dives sur Mer (FR)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH

(21) Appl. No.: 12/500,954

(22) Filed: Jul. 10, 2009

Related U.S. Application Data
(63) Continuation of application No. PCT/EP2008/050277, filed on Jan. 11, 2008.

(30) Foreign Application Priority Data
Jan. 12, 2007 (DE) DE102007001874.8

(51) Int. Cl. B60T 17/08

(52) U.S. Cl. 303/9.76

(57) ABSTRACT

A combined service brake and spring brake cylinder includes a service brake piston arranged in a service brake cylinder and actuated by a pressure medium, and a spring brake piston arranged in a spring brake cylinder and actuated by an accumulator spring. The spring brake piston is connected to a spring brake piston rod which extends through an opening of a partition separating the service brake cylinder and the spring brake cylinder. The partition is provided with a connection for a pressure medium, including a borehole for the supply and/or discharge of the pressure medium into or out of the service brake chamber or spring brake chamber. The connection for a pressure medium contains a separate coupling part held in the borehole and used for connection to a partner coupling part connected to a tube, a line, or a duct for a pressure medium such that the pressure medium is conducted through the elements.

### CROSS-REFERENCE TO RELATED APPLICATIONS

This application is a continuation of PCT International Application No. PCT/EP2008/050277, filed Jan. 11, 2008, which claims priority under 35 U.S.C. § 119 to German Patent Application No. DE 10 2007 001 874.8, filed Jan. 12, 2007, the entire disclosures of which are herein expressly incorporated by reference.

### BACKGROUND AND SUMMARY OF THE INVENTION

The invention is based on a combined service brake and spring brake cylinder for vehicles, having at least one service brake piston which is arranged in a service brake cylinder. The piston can be actuated by way of a pressure medium and delimits a service brake chamber. The piston is connected to a service brake piston rod, which acts on brake actuating elements. The combined device also has at least one spring brake piston, which is arranged in a spring brake cylinder and which can be actuated by way of an accumulator spring. At one side, the spring brake piston is delimited by a spring brake chamber and, on the opposite side, delimits a spring chamber which holds the accumulator spring, and is connected to a spring brake piston rod which extends through an opening in an intermediate wall which separates the service brake cylinder and the spring brake cylinder from one another. A pressure medium connection, which has a bore for the supply and/or discharge of pressure medium into and/or out of the service brake chamber or into and/or out of the spring brake chamber, is provided in the intermediate wall.

For the actuation of brakes in utility or commercial vehicles, use is made, among other things, of combined pneumatic service brake and spring brake cylinders. A combination cylinder of this type is a series connection of a combination of a service brake cylinder, for the actuation of the service brake, and a spring brake cylinder, for the actuation of the auxiliary and spring parking brake.

A generic combined service brake and spring brake cylinder of a utility vehicle is described in DE 35 03 216 A1. There, the pressure medium connection, which is formed in the intermediate wall, is formed by a bore with an internal thread into which a connecting piece of a pressure medium line can be screwed. The pressure medium connection then connects the pressure medium line to the service brake chamber. Pressure medium lines or connecting pieces of this type may have different diameters or dimensions depending on the customer requirements of the vehicle manufacturer, such that the suppliers of the combined service brake and spring brake cylinder must adapt the intermediate wall in each case.

In contrast, it is the object of the invention to further develop a combined service brake and spring brake cylinder of the above-mentioned type such that it can be used more flexibly while having favorable production and assembly costs.

According to the invention, the pressure medium connection includes at least one separate coupling part, which is held in the bore and which is provided for the pressure-medium-conducting connection to a partner coupling part, which is connected to a pressure medium pipe, a pressure medium line, or to a pressure medium duct. It is then possible for an adaptation to different diameters and sizes of pressure medium pipes, pressure medium lines, pressure medium ducts or partner coupling parts to be provided in a simple manner by inserting a correspondingly adapted coupling part into the bore. In this way, the production of different separating walls with, in each case, different bore or thread diameters, can be dispensed with. It consequently suffices to provide a uniform bore with identical internal dimensions in the separating walls, into which bore is then inserted the coupling part, which is standardized with regard to its external dimensions. The differences are accordingly restricted to the, in each case, other connecting geometries between the coupling part and the partner coupling part, which are predefined by the vehicle manufacturer.

Advantageous refinements and improvements to the invention are described herein.

The coupling part is particularly preferably held in the bore in a positively locking fashion, with the positively locking action being produced, for example, by way of a snap-action connection. This may, for example, be realized in that at least one at least axially resilient elastic snap ring is provided, which snap ring is held in the groove which runs around in the shape of a circular ring and which is formed in the radially inner bore wall of the bore. The snap ring projects radially inward beyond the groove with a spring section which is designed so as to deflect or snap into a recess of the coupling part in a positively locking fashion when the coupling part is plugged or inserted into the bore. A snap-action connection of this type can be produced in a very fast and simple manner, in particular with low assembly forces.

The recess in the coupling part for the snap ring and the spring section of the snap ring are preferably arranged obliquely with respect to a central axis of the coupling part or of the bore, in such a way that the positively locking action between the bore and the coupling part is non-releasable once it has been formed. According to one refinement, it may be provided that the snap ring is secured by a retaining ring which is held in a further groove of the bore. The retaining ring then forms a wall of the groove which holds the snap ring. The other wall of the groove is, for example, formed by an offset of the bore.

The coupling part particularly preferably supports at least one sealing ring, which seals off with respect to the radially inner bore wall of the bore. Here, provision is made in particular of a sealing ring which interacts in a gas-tight and pressure-tight manner with the bore wall, and of a further sealing ring which is positioned downstream thereof in the direction of the pressure gradient and which prevents at least a penetration of moisture and/or dirt. The positively locking connection is situated between the at least two sealing rings. This prevents contamination or corrosion of the positively locking connection. Secondly, a gas-tight or pressure-tight design of the coupling connection is thereby ensured.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a semi-cross-sectional illustration view of a combined service brake and spring brake cylinder;

FIG. 2 is a cross-sectional illustration view of a pressure medium connection of the combined service brake and spring brake cylinder from FIG. 1 according to one preferred embodiment of the invention; and

FIG. 3 is an enlarged cutout from the cross-sectional illustration view from FIG. 2.

### DETAILED DESCRIPTION OF THE DRAWINGS

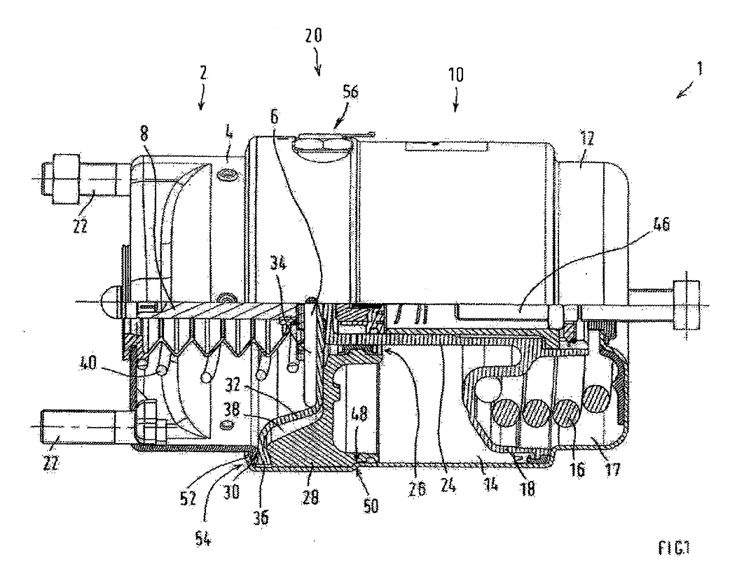

FIG. 1 shows a combined service brake and spring brake cylinder according to a preferred embodiment of the invention. The combined service brake and spring brake cylinder includes a service brake device 2 having a service brake cylinder 4 composed of steel, in which service brake cylinder 4 is guided a service brake piston 6, which can be acted on pneumatically and which, by way of a service brake piston rod 8, actuates, for example, a disc brake (not shown for reasons of scale) of a utility vehicle. Also provided is a spring brake device 10 having a spring brake cylinder 12 composed of steel, in which spring brake cylinder 12 is guided a spring brake piston 18, which can be loaded by pneumatic pressure in a spring brake chamber 14, against the spring force of an accumulator spring 16 in a spring chamber 17, and by which the service brake piston 6 can be acted on in the brake application direction. The service brake cylinder 4 and the spring brake cylinder 12, arranged coaxially in series, form a combination brake cylinder 20. Furthermore, fastening bolts 22 composed of steel project away from the service brake cylinder 4 at the head side, in order to be able to fasten the combination brake cylinder 20 to the vehicle (disc brake).

A spring brake piston rod 24 of the spring brake piston 18 projects in a sealing fashion through a passage opening 26 in a separating wall 28 between the spring brake cylinder 12 and the service brake cylinder 4, and can abut with its end surface against the service brake piston 6. The service brake piston 6 may include an axially movable diaphragm 32, which is secured at its outer edge between the separating wall 28 and a radially outer shoulder 30 on the edge of the service brake cylinder 4, and a central piston disc 34, which is connected to the diaphragm 32.

The shoulder 30 is preferably bent by an angle of greater than 90 degrees, so as to generate an oblique contact surface with respect to the diaphragm 32. Secondly, the separating wall 28 is also provided, at its radially outer edge, with an oblique contact surface, so as to generate between them a cross section which widens radially outwards in the form of a wedge and in which the complementarily shaped outer edge 36 of the diaphragm 32 is held in a positively locking fashion.

It is also possible, in a known way, for the spring brake piston 18 to be placed into a release position, counter to the action of the accumulator spring 16, by introducing pressure (aerating) into the spring brake chamber 14. Furthermore, by aerating a service brake chamber 38, which extends between the separating wall 28 and the service brake piston 6, it is possible for the piston 6 to be placed into an application position, counter to the action of a restoring spring 40 which is supported at one side against the service brake piston 6 and at the other side against an end wall of the service brake cylinder 4. Not least, a mechanical release device 46 is integrated within the spring brake piston rod 24, by which mechanical release device 46 an emergency or auxiliary release of the spring brake can be carried out in the event of a pressure failure.

Furthermore, the radially outer circumference of the separating wall 28 is secured with an offset 48 against a complementary offset 50 of the spring brake cylinder 12. At the other side, the edge 52 of the spring brake cylinder is connected to the edge of the service brake cylinder 4 by a flange 54, which simultaneously encompasses the edge 36 of the diaphragm 32 so as to fasten the latter.

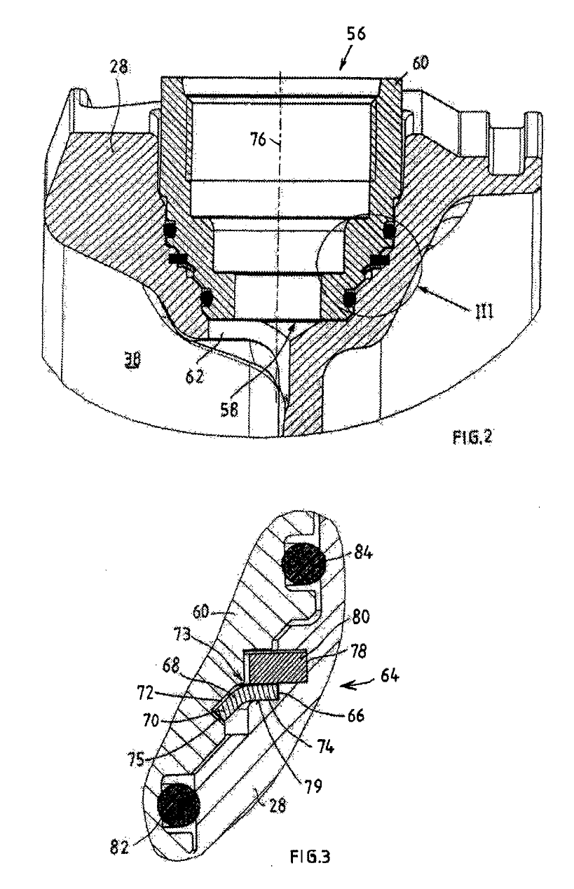

A pressure medium connection 56, which is shown most clearly in FIG. 2, is provided in the separating wall or intermediate wall 28. The pressure medium connection 56 includes at least one separate coupling part 60, which is held in a blind bore 58 formed in a radially outer circumferential surface of the separating wall 28. The coupling part 60 is provided for the pressure-medium-conducting and releasable connection to a partner coupling part (not shown here), which is connected to an external pressure medium pipe, an external pressure medium line or to an external pressure medium duct. The partner coupling part can, for example, be screwed into the coupling part 60. The pressure medium connection 56 serves for the supply and/or discharge of pressure medium into and/or out of the service brake chamber 38 and, alternatively, for the supply and/or discharge of pressure medium into and/or out of the spring brake chamber 14. The blind bore 58 is for example connected to the service brake chamber 38 by a duct 62 which is formed in the base of the blind bore 58.

The coupling part 60 is particularly preferably held in the blind bore 58 in a positively locking fashion, with the positively locking action being produced for example by a snap-action connection 64, which is shown most clearly in FIG. 3. The snap-action connection is preferably realized in that at least one axially resilient elastic snap ring 68 is provided, which snap ring 68 is held in a groove 66 which runs around in the shape of a circular ring and which is formed in the radially inner bore wall of the blind bore 58. The snap ring 68 projects radially inward a short distance beyond the groove 66 with a spring section 70. The spring section 70 of the snap ring 68 is designed so as to deflect or snap into a radially outer recess 72 of the coupling part 60 in a positively locking fashion when the coupling part 60 is plugged or inserted into the blind bore 58. Furthermore, a radially inner section 74 of the elastic snap ring 68 is arranged perpendicular to a central axis 76 of the coupling part 60 or of the blind bore 58, so as to be able to be held in the groove 66 of the blind bore 58. Here, the blind bore 58 is of stepped design and thereby has at least one axial stop for the complementarily stepped coupling part 60 in order to ensure a defined axial position in the installed state.

The elastic snap ring 58 is preferably secured by a retaining ring 80, which is held in a further groove 78 of the blind bore 58 and which is, for example, not provided so as to be fully encircling but rather is provided with a circumferential gap, such that the retaining ring 80 can be compressed radially with a reduction in its outer diameter. After the elastic snap ring 68 has been placed onto an offset 79 in the blind bore 58, which offset 79 forms, at the end side, a wall of the groove 66, the retaining ring 80 is then compressed in order, when released, to be allowed to deflect into its associated groove 78, as a result of which contact is made with the elastic snap ring 68 axially counter to the direction in which the coupling part 60 is pulled out of the blind bore 58. The elastic snap ring 68 is thereby secured. That end side of the retaining ring 80 which faces toward the snap ring 68 therefore forms the other wall of the groove 66 in which the elastic snap ring 68 is held.

The recess 72 in the coupling part 60 for the snap ring 68 and the spring section 70 of the snap ring 68 are particularly preferably arranged obliquely with respect to the central axis 76 of the coupling part 60 or of the blind bore 58, in such a way that the positively locking action between the blind bore 58 and the coupling part 60 is non-releasable once it has been formed. In the present case, for this purpose, the spring section 70 of the snap ring 68 and the recess 72 are angled in the plug-in or insertion direction of the coupling part 60 into the blind bore 58. Furthermore, the recess 72 in the coupling part 60 is of complementarily wedge-shaped design corresponding to the bend angle of the spring section 70 of the snap ring 68.

As the coupling part 60 is inserted into the blind bore 58, therefore, the spring section 70 of the snap ring 68 is firstly deformed axially in the insertion direction and, once it has passed an upper edge rim 73 of the recess 72 in the coupling part 60, deflects or snaps into the recess 72. In this position, the radially inner circumferential surface of the spring section 70 of the snap ring 68 is secured against an associated end surface 75 of the recess 72, such that the coupling part 60 cannot be released and pulled out of the blind bore 58 without being damaged.

The coupling part 60 particularly preferably supports at least one sealing ring, which seals off with respect to the radially inner bore wall of the blind bore 58. More precisely, provision is made of a sealing ring 82 which interacts in a gas-tight and pressure-tight manner with the bore wall, and of a further sealing ring 84 which is positioned downstream thereof in the direction of the pressure gradient and which prevents at least a penetration of moisture and/or dirt, with the positively locking snap-action connection 64 being situated between the at least two sealing rings 82, 84 as viewed in the direction of the pressure gradient.

The coupling part 60 and/or the partner coupling part are composed preferably of steel, brass or a plastic. Likewise, any other desired material which has the stiffness and strength required for pressure-medium-conducting coupling parts can be used.

Against this background, the mode of operation of the combined service brake and spring brake cylinder 1 is as follows.

Proceeding from the situation shown in FIG. 1, in which both the spring brake and also the service brake are released, in order to apply the service brake, the service brake chamber 38 is aerated via the pressure medium connection 56, whereupon firstly the service brake piston 6 is moved away from the separating wall 28 to the left. The movement of the service brake piston 6 causes the disc brake to be applied.

In contrast, a deaeration of the service brake chamber 38 has the effect that the service brake piston 6 is moved by the restoring spring 40 into the release position, that is to say to the right in FIG. 1, and abuts against the end surface of the spring brake piston rod 24 or against the separating wall 28.

To hold the service brake in the applied position for relatively long periods of time, that is to say if the pneumatic pressure in the service brake chamber 38 has depleted after some time or the service brake chamber 38 has been deaerated in a targeted fashion, the spring brake should now be applied. For this purpose, the spring brake chamber 14 is deaerated, whereupon the accumulator spring 16 forces the spring (parking) brake piston 18 together with the spring brake piston rod 24, which is in contact at the end side with the service brake piston 6, to the left in FIG. 1. This movement is followed by the service brake piston 6 and by the service brake piston rod 8, which is coupled thereto, and which places or holds the disc brake in the applied position.

### TABLE OF REFERENCE SYMBOLS

1 Combined service brake and spring brake cylinder
2 Service brake device
4 Service brake cylinder
6 Service brake piston
8 Service brake piston rod
10 Spring brake device
12 Spring brake cylinder
14 Spring brake chamber
16 Accumulator spring
17 Spring chamber
18 Spring brake piston
20 Combination brake cylinder
22 Fastening bolt
24 Spring brake piston rod
26 Passage opening
28 Separating wall
30 Shoulder
32 Diaphragm
34 Piston disc
36 Edge
38 Service brake chamber
40 Restoring spring
46 Release device
48 Offset
50 Offset
52 Edge
54 Flange
56 Pressure medium connection
58 Blind bore
60 Coupling part
62 Duct
64 Snap-action connection
66 Groove
68 Snap ring
70 Spring section
72 Recess
73 Edge rim
74 Radially inner section
75 End surface
76 Central axis
78 Groove
79 Offset
80 Retaining ring
82 Sealing ring
84 Sealing ring

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A combined service brake and spring brake cylinder for a vehicle, comprising:
at least one service brake piston arranged in a service brake cylinder and being actuatable by a pressure medium, the service brake piston delimiting a service brake chamber and being connected to a service brake piston rod operatively configured to act on brake actuating elements;
at least one spring brake piston arranged in a spring brake cylinder and being actuatable via an accumulator spring, the spring brake piston delimiting at one side a spring brake chamber and, on an opposite side, a spring chamber holding the accumulator spring, wherein the spring brake cylinder is connected to a spring brake piston rod extending through an opening in an intermediate wall separating the service brake cylinder and the spring brake cylinder;
a bore for at least one of supplying and discharging a pressure medium into and/or out of the service brake chamber or into and/or out of the spring brake chamber, the bore being provided in the intermediate wall; and
at least one separate coupling part held in the bore, the separate coupling part being operatively configured to provide a pressure-medium connection to a partner coupling part connected to a pressure medium conduit.

2. The combined service brake and spring brake cylinder according to claim 1, wherein the pressure medium conduit is one of a pipe, line, and duct.

3. The combined service brake and spring brake cylinder according to claim 1, wherein the separate coupling part is positively locked in the bore.

4. The combined service brake and spring brake cylinder according to claim 3, wherein the positive locking of the coupling part in the bore is performed by a snap-action connection.

5. The combined service brake and spring brake cylinder according to claim 4, wherein the snap-action connection comprises:
at least one axially resilient elastic snap ring; and
a groove extending in the shape of a circular ring around a radially inner bore wall of the bore, the elastic snap ring being held in the groove and projecting radially inward beyond the groove with a spring section operatively configured to deflect or snap into a recess of the coupling part in a positively locking manner when the coupling part is inserted into the bore.

6. The combined service brake and spring brake cylinder according to claim 5, wherein the recess for the snap ring in the coupling part and the spring section of the snap ring are arranged obliquely with respect to a central axis of the coupling part such that the positive lock between the bore and the coupling part is non-releasable once formed.

7. The combined service brake and spring brake cylinder according to claim 5, wherein the snap ring is secured axially by a retaining ring, which is held in a groove in the radially inner bore wall of the bore.

8. The combined service brake and spring brake cylinder according to claim 6, wherein the snap ring is secured axially by a retaining ring, which is held in a groove in the radially inner bore wall of the bore.

9. The combined service brake and spring brake cylinder according to claim 1, wherein the coupling part supports at least one sealing ring, which seals off with respect to a radially inner bore wall of the bore.

10. The combined service brake and spring brake cylinder according to claim 5, wherein the coupling part supports at least one sealing ring, which seals off with respect to the radially inner bore wall of the bore.

11. The combined service brake and spring brake cylinder according to claim 6, wherein the coupling part supports at least one sealing ring, which seals off with respect to the radially inner bore wall of the bore.

12. The combined service brake and spring brake cylinder according to claim 3, further comprising:
at least one sealing ring interacting in a gas-tight and pressure-tight manner with a bore wall;
a second sealing ring positioned downstream of the at least one sealing ring in a direction of a pressure gradient, the second sealing ring preventing at least a penetration of moisture and/or dirt; and
wherein the positive lock of the coupling part in the bore is arranged between the two sealing rings viewed in a direction of the pressure gradient.

13. The combined service brake and spring brake cylinder according to claim 5, further comprising:
at least one sealing ring interacting in a gas-tight and pressure-tight manner with a bore wall;
a second sealing ring positioned downstream of the at least one sealing ring in a direction of a pressure gradient, the second sealing ring preventing at least a penetration of moisture and/or dirt; and
wherein the positive lock of the coupling part in the bore is arranged between the two sealing rings viewed in a direction of the pressure gradient.

14. The combined service brake and spring brake cylinder according to claim 1, wherein the bore has a stepped configuration including at least one axial stop for the coupling part.

15. The combined service brake and spring brake cylinder according to claim 5, wherein the bore has a stepped configuration including at least one axial stop for the coupling part.

16. The combined service brake and spring brake cylinder according to claim 6, wherein the bore has a stepped configuration including at least one axial stop for the coupling part.
